(19) United States
(12) Patent Application Publication
(10) Pub. No.: US 2005/0069330 A1
(43) Pub. Date: Mar. 31, 2005

(54) System and method for optical transmission

(76) Inventors: Yuan-Hua Kao, Somerset, NJ (US); Xiang Liu, Marlboro, NJ (US); Xing Wei, New Providence, NJ (US)

Correspondence Address: Docket Administrator (Room 3J-219);Lucent Technologies Inc., 101 Crawfords Corner Road, Holmdel, NJ, 07733-3030, US

(21) Appl. No.: 10/673,933

(22) Filed: Sep. 29, 2003

(51) Int. Cl. H04B 10/04

(52) U.S. Cl. 398/188

(57) ABSTRACT

A system and method for generating multilevel coded optical signals for optical transmission are disclosed. The method comprises driving modulators with synchronous data signals having the same data rate to generate a multilevel optical signal using differential phase shift keying and amplitude shift keying modulation.

### FIELD OF THE INVENTION

The present invention relates generally to wavelength division multiplexed (WDM) optical transmission, and more specifically to a system and method for generating multilevel coded optical signals.

### BACKGROUND OF THE INVENTION

Multilevel amplitude-shift-keying (M-ary ASK) provides a means for increasing the information spectral density or the capacity of a transmission system. M-ary ASK also substantially improves system tolerance to chromatic dispersion and polarization-mode-dispersion (PMD) by lowering the symbol rate for a given bit rate.

Quaternary (4-ary) ASK modulation formats have been proposed and demonstrated in the prior art. In a 4-ary ASK format, each symbol has four different optical intensities but the same phase. Such a format is discussed in Walklin and Conradi, “Multilevel Signaling For Increasing The Reach of 10 Gb/s Lightwave Systems”, Journal of Lightwave Technologies, Vol. 17, pp. 2235-2248 (1999), which is incorporated herein by reference. This format, however, suffers a large power penalty as compared to a conventional binary format with the same overall data rate, which precludes the use of 4-ary ASK for conventional DWDM transmissions. The performance of this format as compared to conventional formats is discussed in detail by Conradi in Chapter 16 of Optical Fiber Telecommunications IVB, Academic Press, which is incorporated herein by reference.

Differential quadrature phase-shift-keying (DQPSK) is another multilevel modulation format, which offers improved tolerance to dispersion and PMD with good receiver sensitivity. DQPSK, however, requires more complex transmitters and receivers as compared to other formats. In the DQPSK format, each symbol has four equally spaced phases but the same intensity. This format is discussed in R. A. Griffin et al., “Optical Differential Quadrature Phase-Shift Key (ODQPSK) For High Capacity Optical Transmission”, Proceedings of OFC 2002 pp. 367-368 (2002), which is incorporated herein by reference.

### SUMMARY OF THE INVENTION

The present invention provides a system and method for generating an optical multilevel signal by differential-phase amplitude-shift keying (DP-ASK) modulation in which two sets of data, one modulated using differential-phase-shift-keying (DPSK) and the other modulated using amplitude-shift-keying (ASK), are modulated and transmitted simultaneously yet independently at a single wavelength. Both the intensity and phase of a CW carrier are modulated to provide four possible symbols for a given information bit.

In one embodiment, a method comprises the step of driving at least two modulators with at least two synchronous data signals having the same data rate to generate an optical signal using differential phase shift keying and amplitude shift keying modulation.

In another embodiment an optical transmission system is provided comprising an optical 4-ary DP-ASK transmitter including at least two modulators adapted to provide an optical 4-ary DP-ASK modulated signal. The system also includes an optical receiver including a DPSK receiver that includes a delay interferometer and a balanced receiver to detect a DPSK modulated portion of the 4-ary DP-ASK modulated signal. The receiver also includes an optical intensity receiver to detect an ASK modulated portion of the 4-ary DP-ASK modulated signal.

### BRIEF DESCRIPTION OF THE DRAWING

FIG. 1 is a diagram depicting one embodiment of an optical system according to the invention.

FIG. 2 is a plot illustrating a constellation diagram of 4-ary DP-ASK symbols.

FIGS. 3a-b are the received electrical eye diagrams of a DPSK portion and an ASK portion of a DP-ASK back-to-back transmission in accordance with an embodiment of the invention.

FIG. 4 is a plot showing the measured BER performance of a system according to an embodiment of the invention.

FIGS. 5a-b are plots showing the measured BER performance and the measured signal spectrum of a system according to an embodiment of the invention.

FIGS. 6a-b are the received electrical eye diagrams of a DPSK portion and an ASK portion of a return-to-zero (RZ) DP-ASK back-to-back transmission in accordance with an embodiment of the invention.

FIG. 7 is a plot showing the measured BER performance of a system in accordance with an embodiment of the invention.

FIG. 8 is a schematic diagram illustrating the use of pre-emphasis through chirped ASK to combat differential-phase eye closure penalty resulting from self-phase modulation (SPM) during nonlinear transmissions.

FIG. 9 is a schematic diagram illustrating the use of post nonlinear phase shift compensation (post-NPSC) to compensate for the differential-phase closure resulting from SPM during nonlinear transmissions.

### DETAILED DESCRIPTION OF THE INVENTION

In preferred embodiments, the present invention provides a system and method for generating optical 4-ary DP-ASK signals for transmission in an optical transmission system using two modulators, one for DPSK modulation and the other for ASK modulation. Such a system allows for the simultaneous yet independent transmission and reception of two data tributaries. Preferably, the two data tributaries have the same data rate and are modulated synchronously such that the bit centers of the two tributaries are aligned in time (to avoid the distortion at the center of ASK bits during the transition between adjacent DPSK bits).

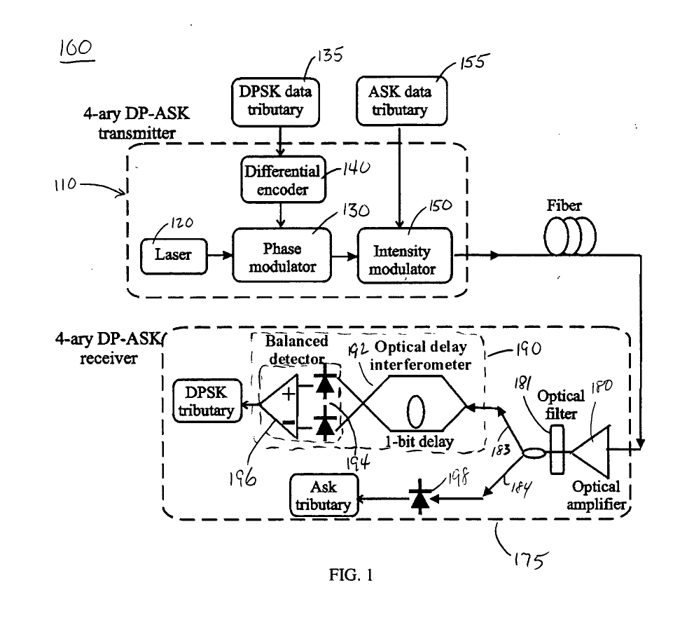

A 4-ary DP-ASK transmitter 110 of one embodiment of a system 100 according to the invention is illustrated in FIG. 1. The light from a laser 120 is first DPSK modulated using one data tributary 135 using a phase modulator 130 which can be a single-waveguide phase modulator, a Mach-Zehnder modulator (MZM) that is biased at null to achieve phase modulation, or the like. The MZM can be made from a variety of electro-optic materials, for example, LiNbO₃, and is preferably biased at its null point to switch the phase of the light signal between 0 and π. A chirp-free MZM is preferred because it produces the DPSK signal with perfect phase values (0 and π).

DPSK encoding is preferably performed using a differential encoder 140 before modulation. An intensity modulator 150 then modulates the DPSK signal using a second data tributary 155. Preferably, the intensity modulator 150 is driven to produce an extinction ratio (ER) of about 6 to 9 dB. The intensity modulator 150 can be a MZM, an electro-absorption modulator (EAM), or the like. For a MZM, a low ER can be achieved by under-driving the MZM and shifting the bias point away from the quadrature point. For modulation with an EAM, a low ER can be achieved by shifting the bias point. The order of the DPSK and ASK modulation of an optical signal may be reversed while still providing a DP-ASK signal according to the invention.

The system 100 preferably also includes a receiver 175. An erbium-doped fiber amplifier 180 (EDFA) is preferably used in the receiver 175 as an optical pre-amplifier. An optical filter 181 is preferably provided after the pre-amplifier 180 to reduce the penalty from amplified-spontaneous-emission (ASE) noise. The amplified signal is then preferably separated into two paths 183, 184. One path 183 transmits the signal to a DPSK receiver 190. The DPSK receiver 190 preferably comprises a one-bit delay interferometer 192, a balanced detector 194, and a differential RF amplifier 196 for detection of the DPSK tributary (i.e., the DPSK modulated portion or component of the signal). The one-bit delay interferometer 192 is preferably provided to divide the light on path 183 into two arms and delay one arm by about one bit period. It can be understood by those skilled in the art that the delay provided by the delay interferometer 192 can vary from precisely one bit period while still providing sufficient delay in accordance with the invention. Preferably, the delay provided by the delay interferometer 192 is between about 0.8 and about 1.2 times the bit period.

The other path 184 transmits the signal to an ASK detector 198 for detection of the ASK tributary portion of the signal.

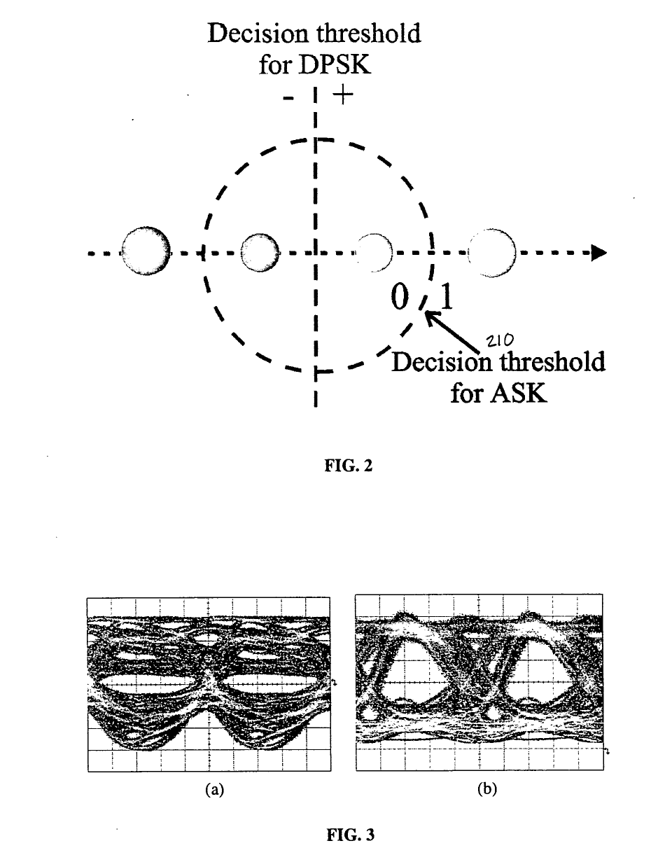

FIG. 2 is a plot illustrating the constellation diagram of four symbols of 4-ary DP-ASK modulation. In the diagram, the x-axis represents the real part of the optical field, and the y-axis represents the imaginary part of the optical field. The DPSK data tributary is recovered by setting the decision threshold at the y-axis to compare the signs (or phases) of adjacent bits, which can be realized by using a delay interferometer 192 and a balanced detector 194 and setting the decision threshold at 0. For example, if two adjacent bits have the same (or opposite) sign, then “1” (or “−1”) is determined. The ASK data tributary is preferably retrieved by setting the decision threshold at the circle 210 with a radius that is the mean of the larger and smaller amplitude of the symbols.

An embodiment of the invention has been demonstrated experimentally with an aggregate 20-Gb/s non-return-to-zero (NRZ) 4-ary DP-ASK signal. The cw source 120 used was a tunable laser operating at 1550 nm. A 10-Gb/s DPSK tributary was modulated on the cw light by a MZM that is biased at null and driven at 2V_{π} to achieve phase modulation. The light was then intensity modulated with ˜8 dB ER to carry a 10-Gb/s ASK tributary. It was found that the ER of the ASK modulation is more preferably about 9.5 dB to achieve equal receiver sensitivity for the two data tributaries. The optical signal-to-noise (OSNR) requirement at a given BER for a 4-ary DP-ASK was determined to be only about 1 dB higher than that for a binary on-off-keying (OOK) format with the same overall data rate. Compared with 4-ary ASK with quadratic power levelling, 4ary DP-ASK requires about 4.5 dB less OSNR for a given BER.

Due to the limited dynamic range of the DPSK receiver used in the experiment it was determined that the preferred ER is about 8 dB. The low ER was achieved by under-driving MZM at about 0.9V_{π}, and shifting the bias point away from the quadrature point of the MZM by about 0.05 V_{π}.

To simplify the transmitter, a commercial chirp-free two-stage integrated MZ modulator was used. The bandwidths of the two MZMs were about 10 GHz. The total insertion loss of the transmitter was about 5.5 dB.

At the receiver 175, an EDFA with about 4.5 dB NF was used as the optical pre-amplifier 180. The optical filter 181 after the pre-amplifier 180 had a 3-dB bandwidth of 100-GHz. The amplified signal was split into two signals, one entering a DPSK receiver 190 comprising a 100-ps delay interferometer 192, a balanced detector 194, and a differential RF amplifier 196, and the other entering an ASK detector. The effective RF bandwidths of the two receivers were about 7 GHz.

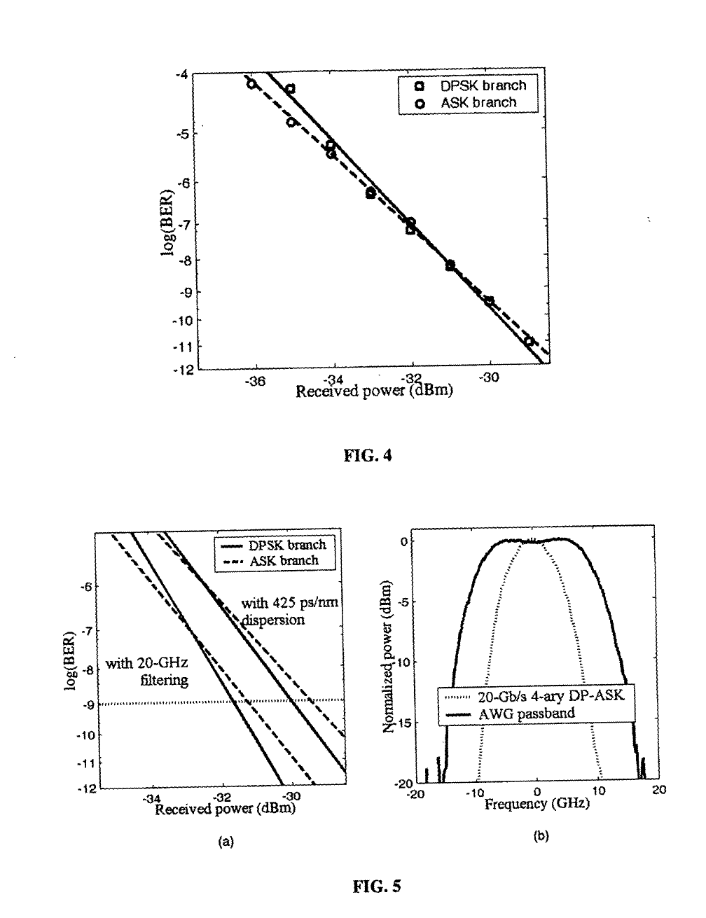

FIGS. 3a-b show the eye diagrams detected at the DPSK and ASK receivers 190, 198. For the DPSK tributary, with the use of the balanced detector 194, the decision level was fixed at 0. FIG. 4 shows the BER performance of both DPSK and ASK vs. the received optical power (before the pre-amplifier).

A pulse pattern generator was used to produce a data stream that consisted of pseudorandom bit sequences (PRBS) with a pattern length of 2⁷−1, and its inverted copy. The DPSK modulator 130 was driven by the data and the ASK modulator 150 by the inverted data which was delayed by ˜30 bits to de-correlate the two data streams to the modulators 130, 150. It is understood that inverted/delayed data was used only for the experimental purpose of generating two data tributaries.

Receiver sensitivity (at BER=10⁻⁹) of −30.5 dBm was achieved for both DPSK and ASK receivers 190, 198. The sensitivity was about 6 dB worse than that of 10-Gb/s binary NRZ (for the experimental embodiment), or about 2 dB worse than the theoretically predicted performance, mainly due to the limited dynamic range of the DPSK receiver 190.

4-ary DP-ASK is understood to have a high tolerance to chromatic dispersion and optical filtering. FIGS. 5a-b show the performance of the 20-Gb/s 4-ary DP-ASK under 425 ps/nm dispersion and under a tight filtering by an arrayed-waveguide-grating (AWG) with 25-GHz channel spacing and ˜20-GHz passband. The dispersion penalties for the DPSK and ASK tributaries were both less than 1 dB, similar to binary 10-Gb/s NRZ transmission. With the filtering, the receiver sensitivities of the DPSK and ASK tributaries were improved by 1 dB and 0.7 dB, respectively. The AWG effectively limits the bandwidth of ASE noise and thus improves the receiver sensitivity. The experimental results also show less than 1 dB penalty when the bandwidth is further reduced to 16 GHz, suggesting that 4-ary DP-ASK may be transmitted at greater than about 100% spectral efficiency. The experiment is described in detail in a paper submitted to ECOC'03 by X. Liu, et al., entitled “Quaternary Differential-Phase Amplitude-Shift-Keying For DWDM Transmission,” which is incorporated herein by reference.

In another embodiment of the invention the 4-ary DP-ASK modulation can be based on a return-to-zero (RZ) pulse format. RZ 4-arv DP-ASK can provide improved receiver sensitivity as compared to NRZ 4-ary DP-ASK. RZ 4-ary DP-ASK can be realized either optically, by using for example, another modulator (not shown) to generate a pulse at each bit slot, or electrically, by using for example, an RZ pulse generator to provide RZ RF data to drive the intensity modulator 150.

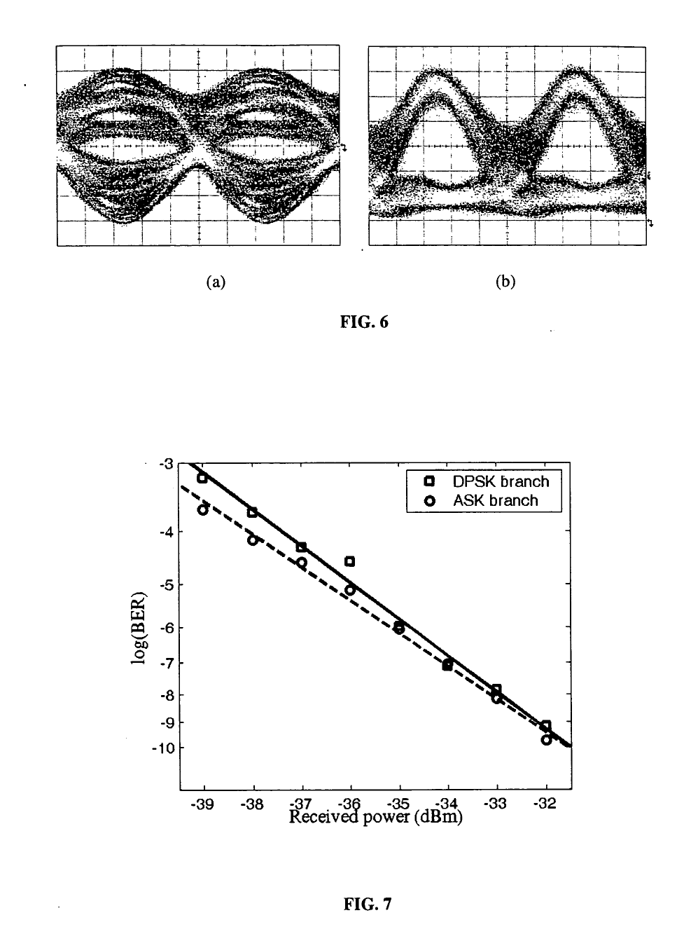

FIGS. 6a-b show the received electrical eye diagrams of the DPSK data tributary and the ASK data tributary of a 20-Gb/s RZ 4-ary DP-ASK back-to-back transmission with pulse generation done electronically. FIG. 7 is a plot showing the measured BER performance of the DPSK tributary and ASK tributary of the 20-Gb/s RZ 4-ary DP-ASK back-to-back transmission. The overall receiver sensitivity of the RZ 4-ary DP-ASK transmission is about 2 dB better than NRZ 4-ary DP-ASK transmission.

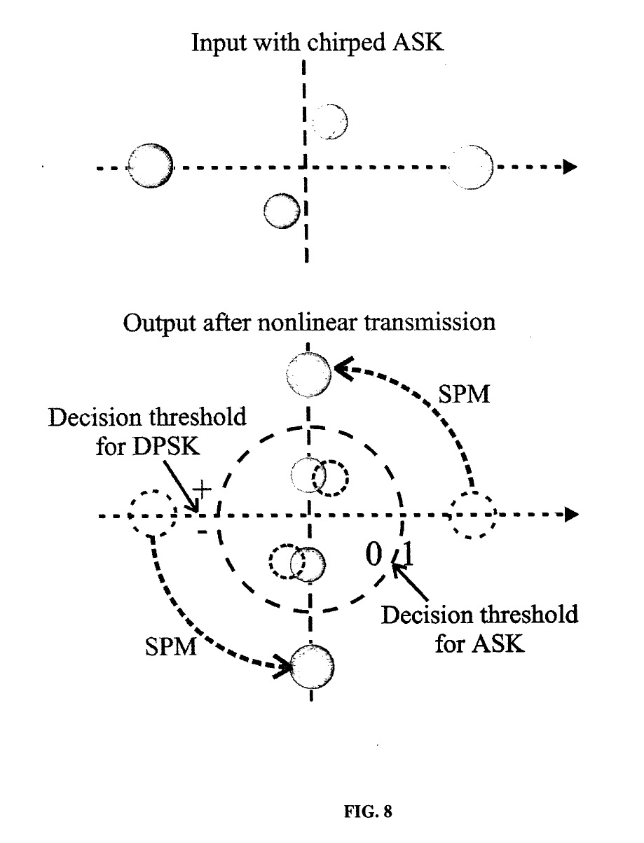

In another embodiment of the invention using 4-ary DP-ASK modulation in nonlinear transmissions, where self-phase-modulation (SPM) induces different phase shifts for signals with different intensities and causes the differential-phase eye closure which degrades the performance of DPSK tributary, pre-emphasis is used to combat the SPM penalty. FIG. 8 is a schematic diagram illustrating the use of pre-emphasis through chirped ASK to combat the SPM penalty. The chirped ASK modulation can be realized by driving one arm of a dual-drive MZM in such a way that any high-intensity “1” has a phase shift which is smaller than the phase shift of a low-intensity “0”. By doing so, after nonlinear transmission over which SPM introduces more phase shift to “1s” than to “0s”, the overall phases of “1s” and “0s” are close to those in the ideal case (as shown in FIG. 2) for optimal receiver sensitivity. Since an optimum nonlinear phase shift is about 1 radian in nonlinear DPSK transmission, a chirped ASK modulation with an ER between about 5 dB and 9 dB is preferred.

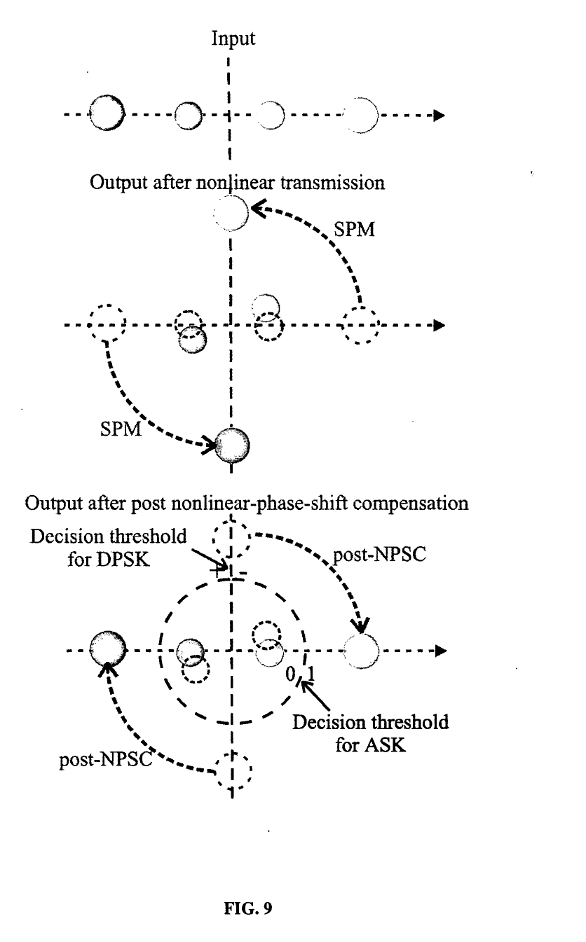

In another embodiment of the invention using 4-ary DP-ASK modulation in nonlinear transmissions, post nonlinear phase shift compensation (post-NPSC) is used to compensate for the SPM-induced differential-phase eye closure. One method of post-NPSC which can be used in accordance with the present invention is disclosed in U.S. patent application Ser. No. 10/331,217, entitled “Nonlinear Phase-Shift Compensation Method And Apparatus”, which is incorporated herein by reference. Detailed descriptions of the post-NPSC method can also be found in X. Liu et al., “Improving Transmission Performance In Differential Phase-Shift-Keyed Systems By Use of Lumped Nonlinear Phase-Shift Compensation”, Optics Letters, Vol. 27, pp. 1616-1618, (2002), and in C. Xu and X. Liu, “Postnonlinearity Compensation With Data-Driven Phase Modulators In Phase-Shift Keying Transmission”, Optics Letters, Vol. 27, pp. 1619-1621 (2002), which are also incorporated herein by reference. FIG. 9 is the schematic diagram illustrating the use of post-NPSC to compensate for the differential-phase closure resulting from SPM during nonlinear transmissions.

Although the present invention has been described in accordance with the embodiments shown, one skilled in the art will readily recognize that there could be variations to the embodiments, and that those variations would be within the spirit and scope of the present invention as defined by the appended claims.

1. A communication method for multilevel coded optical signal transmission comprising the step of:
driving at least two modulators with at least two synchronous data signals having the same data rate to generate an optical signal using differential phase shift keying and amplitude shift keying modulation.

2. The method of claim 1 further comprising receiving the optical signal using a receiver including a balanced detector for detection of the differential phase shift keyed portion of the optical signal.

3. The method of claim 1 further comprising providing post nonlinear-phase-shift compensation to substantially reduce the penalty from self-phase-modulation during nonlinear transmission.

4. The method of claim 1 wherein the amplitude shift keying modulation generates chirp-free optical signals.

5. The method of claim 1 wherein the amplitude shift keying modulation generates chirped optical signals.

6. The method of claim 1 wherein the amplitude shift keying modulation has an extinction ratio of between about 5 dB and about 10 dB.

7. The method of claim 1 further comprising providing pulse generation to allow for generation of RZ optical signals.

8. A transmitter apparatus for generating differential phase amplitude shift keyed optical signals comprising:
a modulator means, including at least two modulators driven by synchronous data signals having the same data rate, adapted to generate an optical signal using differential phase shift keying and amplitude shift keying modulation.

9. The apparatus of claim 8 wherein the at least two modulators are modulators selected from the group consisting of a Mach-Zehnder modulator, a single-waveguide modulator, or an electro-absorption modulator.

10. The apparatus of claim 8 wherein the modulator means is adapted to provide chirp-free amplitude shift keying modulation.

11. The apparatus of claim 8 wherein the modulator means is adapted to provide chirped amplitude shift keying modulation.

12. The apparatus of claim 8 wherein the extinction ratio of amplitude shift keying modulation is between about 5 dB and about 10 dB.

13. The apparatus of claim 8 further comprising a differential encoder means coupled to the modulator means.

14. The apparatus of claim 8 further comprising a pulse generator operatively coupled to the modulator means to allow for generation of RZ optical signals.

15. An optical transmission system comprising:
a first modulator adapted to receive a first data signal;
a second modulator coupled to the first modulator and adapted to receive a second data signal;
wherein the first and second data signals are synchronous and have the same data rate, and wherein the first and second modulators are adapted to generate a multilevel coded optical signal using differential phase shift keying and amplitude shift keying modulation.

16. The system of claim 15 further comprising a receiver including a balanced detector for detection of a differential phase shift keyed portion of the optical signal.

17. The system of claim 16 wherein the receiver further comprises a post nonlinear-phase-shift compensator for substantially reducing the penalty from self-phase-modulation during nonlinear transmission.

18. An optical transmission system comprising:
an optical 4-ary DP-ASK transmitter including at least two modulators adapted to provide an optical 4-ary DP-ASK modulated signal; and
an optical receiver including:
a DPSK receiver including a delay interferometer and a balanced receiver to detect a DPSK modulated portion of the 4-ary DP-ASK modulated signal; and
an optical intensity receiver to detect an ASK modulated portion of the 4-ary DP-ASK modulated signal.
